(19) United States
(12) Patent Application Publication
(10) Pub. No.: US 2010/0002824 A1
(43) Pub. Date: Jan. 7, 2010

(54) Neutron bundles for energy and element production

(76) Inventor: Willard Henry Schmidt, Albuquerque, NM (US)

Correspondence Address: Willard H. Schmidt, 2015 Altez NE, Albuquerque, NM, 87112, US

(21) Appl. No.: 12/217,105

(22) Filed: Jul. 2, 2008

(51) Int. Cl. G21G 1/06; G21G 1/10

(52) U.S. Cl. 376/158; 376/194

(57) ABSTRACT

Neutron bundles are formed as a result of interactions between polarized atomic core neutrons and anti-polar neutrons injected into atomic cores. Neutron bundles are groups of neutrons that can be produced and used in a process for making elements and isotopes, and also used in a process for the production of nuclear binding energy as the ultimate clean fuel for energy with an unlimited supply. Elements and isotopes are formed upon the introduction of protons onto neutron bundles. Nuclear fusion energy is produced when neutron bundles are made to react with each other in equipment designed for this purpose that includes a neutron bundle nuclear chain reactor.

### BACKGROUND-DESCRIPTION OF PRIOR ART

The elements and isotopes in the Mendeleev Periodic Chart of the Elements, and in the Segre Chart of the Nuclides, are real and they exist in the crust of the earth. The elements were formed from free neutrons following the so-called Big Bang event from which the universe developed. Neutrons subsequently decayed into protons and electrons, and these particles formed atoms. It is common belief that the various elements were formed sequentially under original conditions of very high temperatures and pressures. However, because of enormous repulsive coulomb electrical forces between atoms, sequential formation of these elements is questionable.

A more likely concept for the formation of elements in the earth's crust is the formation of elements starting with neutron bundle configurations to which protons are selectively added. That is the concept presented here, and it is called Neutron Bundle Growth.

### SUMMARY OF THE INVENTION

This invention defines neutron bundles, and describes how they can be formed and used to produce elements and to yield nuclear binding energy as a result of nuclear fusion reactions. Neutron bundles are groups of neutrons that are formed as a result of nuclear interactions between polarized atomic core neutrons and anti-polar neutrons injected into atomic cores. Elements are formed upon introduction of protons onto neutron bundles. Very large amounts of nuclear fusion binding energy are released when neutron bundles, classified as boson nuclear particles, are made to impact with each other. Designs of devices used in these processes are presented, including a design for a neutron bundle nuclear chain reactor for power generation.

### DRAWING FIGURES

FIG. 1 indicates the two possible quantum mechanical orientations for free neutrons. One orientation is spin up, and the other is spin down.

FIG. 2 is a sketch of polarized neutrons in an atomic core.

FIG. 3 is an illustration of a NeuX, or neutron bundle, production system.

FIG. 4 indicates the possible formation of NeuX particles in an atomic core.

FIG. 5 illustrates element formation from NeuX neutron particle bundles.

FIG. 6 is a schematic of an Aluminum atom showing the polarized neutron core.

FIG. 7 is an illustration of Neu4 particles imbedded in a crushable pellet

FIG. 8 illustrates an implosion sphere used for NeuX energy production

FIG. 9 is a schematic of an imbedded NeuX pellet impact device.

FIG. 10 represents a neutron bundle nuclear fission chain reactor.

### REFERENCE NUMERALS IN DRAWINGS

1. Neutron particle with spin up
2. Neutron particle with spin down
3. Neu2 neutron particle
4. Neu4 neutron particle
5. Radioactive source of alpha particles
6. Alpha particle
7. Boron-10 material target
8. Proton particle
9. NeuX neutron bundle accumulator container
10. Thermal neutron source
11. Electrical cable wound solenoid
12. Electron
13. Containment sphere with high explosive blanket
14. Imbedded NeuX neutron bundle pellet
15. Neutron bundle interaction chamber
16. Neutron bundle pellet injection tube
17. Crushable sphere
18. Nuclear reactor container
19. Fuel element
20. Control element
21. Neutron source
22. Electrical solenoid

### DESCRIPTION OF INVENTION

This invention describes a new process for the formation and manufacture of elements and isotopes, and a new process for the production of nuclear binding energy from the interaction and nuclear fusion of bundles of neutrons, and the equipment for performing these new processes.

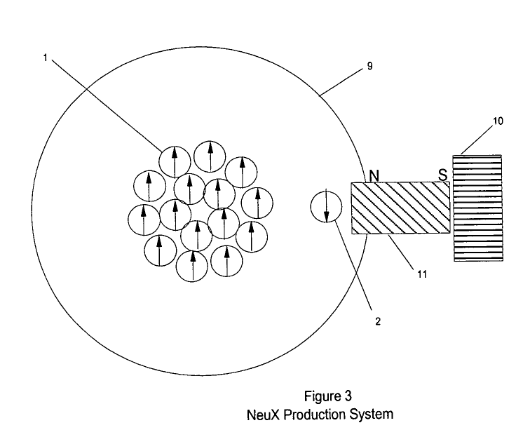

This invention consists of a process for the formation of neutron bundles 3, 4, a process for the formation of various elements and isotopes from neutron bundles, a means of producing energy using neutron bundles, and the equipment required for these processes. These processes are illustrated in FIGS. 3, 4, 5, 8, and 9.

Equipment for the formation of neutron bundles 3,4 consists of an accumulator container 9 in which polarized atomic core neutrons of solid target material are located, and a thermal neutron source 10 that feeds thermal neutrons into an electrical cable wound solenoid 11 where the solenoid magnetic field orients the polarity of injected neutrons to oppose the polarity of the polarized core neutrons.

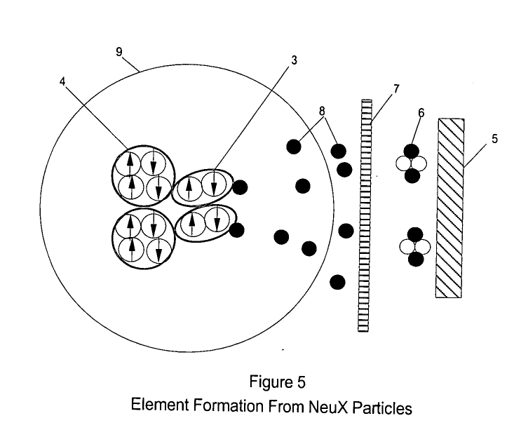

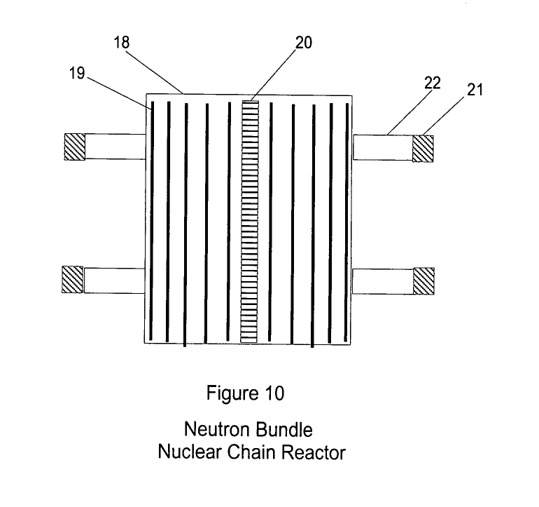

The equipment arrangements that are shown in FIGS. 3 and 5 respectively are both located adjacent to container 9, but are shown separately for clarity reasons in FIGS. 3 and 5. A schematic drawing of a neutron bundle nuclear chain reactor is presented in FIG. 10.

### Operation of Invention

### Neutron Bundles

The formation of elements and isotopes is accomplished by using neutron bundles 3,4 and by the injection of proton particles 8 upon the neutron bundles 3,4.

The formation of neutron bundles 3,4 occurs by nuclear fusion reactions when anti-polar neutrons 2 are injected into an atomic core of polarized neutrons. This process is the formation of neutron bundles 3,4 by nuclear fusion reactions when anti-polar neutrons are injected into an atomic core of polarized neutrons.

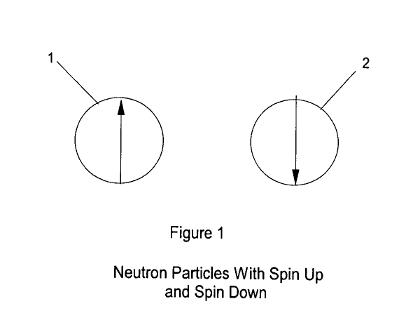

The purpose of this invention is to first build bundles of neutrons 3, 4, from neutrons 1,2, shown in FIG. 1, and second to associate the proper number of protons 8 with neutron bundles 3,4 to form specific elements and isotopes. Nuclear fusion binding energy is released when neutron bundles 3, 4 are made to interact with one another. The nuclear fusion binding energy released from the interaction of neutron bundles is a very large amount of energy.

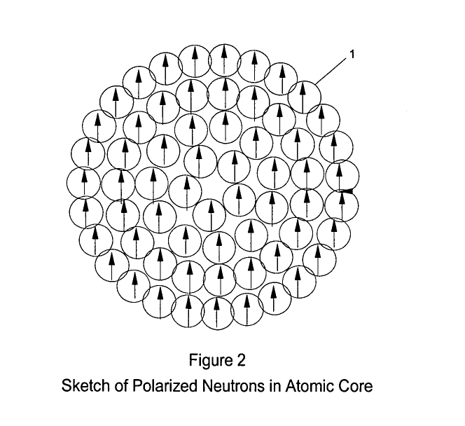

FIG. 1 illustrates the different polarity of neutrons 1,2. FIG. 2 illustrates an atomic core consisting of polarized neutrons 1. Atoms and atomic cores are spherical, and the two dimensional drawings here are meant to simulate spherical geometry. The introduction of anti-polar neutrons 2 into an atomic core of polarized neutrons 1 is shown in FIG. 3. In this figure a thermal neutron source 10 feeds thermal neutrons into electrical cable wound solenoid 11. The solenoid magnetic field orients the polarity of injected neutrons to oppose the polarity of the polarized core neutrons. Reactions between the oppositely polarized neutrons take place, and subsequently neutron bundles are formed. This is all done under high vacuum conditions inside of the accumulator container 9 where the neutron bundles 3,4 are stored.

Neutrons have a magnetic moment of negative 1.906 nuclear magnetons. This may be surprising since the neutron is an electrically neutral particle. The magnetic moment is simply defined as the orbit current times area of the orbit, and is equal to a constant times the angular momentum. A nuclear magneton is the atomic unit of magnetic moment.

Neutron particles have a radius of about 1.2×10⁻¹³ cm. Free neutrons are radioactive with a half-life of 10.6 minutes, and decay into a proton with the emission of a negative electron and an anti-neutrino. The neutron is classified as a fermion particle. It is subject to the Pauli Exclusion Principal, which precludes fermion nuclear particles from having the same set of quantum numbers. This is important to emphasize here because the Pauli Exclusion Principal is used to advantage in this patent application, and neutron polarity is a key factor.

An important and unique observation in this patent application is that atomic core neutrons are naturally polarized from both the standpoints of magnetic moment and angular momentum. See FIG. 2, which shows atomic core neutrons 1 all polarized in the same direction.

Neutron angular momentum, or spin, for fermion particles, which include neutrons, is a quantum mechanical quantity defined as plus or minus half integer values of h/2π. Planck's constant, h, has a value of 6.625×10⁻²⁷ erg-sec. For atomic stability it is necessary that core neutrons be naturally polarized. If not polarized they could react with one another. Atomic core neutrons are densely packed due to pion interchange particles that are responsible for the strong nuclear force between neutrons.

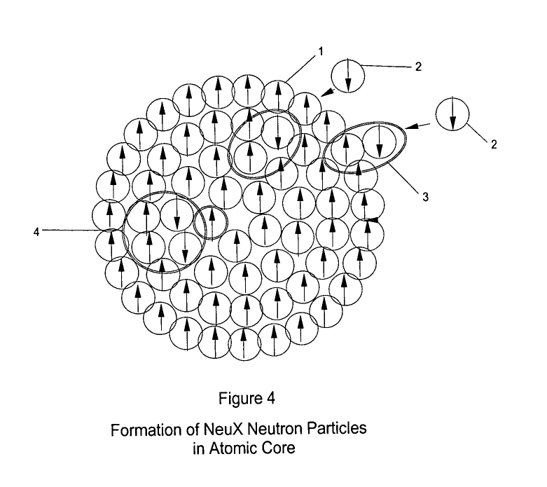

In this patent application, the fact that atomic core neutrons 1 are naturally polarized is used to advantage. Anti-polar neutrons 2 are introduced to react with the core neutrons and form Neu2 and Neu4 particles, as shown in FIGS. 3 and 4. The Pauli Exclusion Principal is not violated here because the interacting neutrons have opposite polarity and do not have the same set of quantum numbers. Neu2 particles are defined as groups of two neutrons. Neu4 particles are groups of 4 neutrons. NeuX particles are groups of X numbers of neutrons, or bundles of neutrons. Neu2 and Neu4 particles have integer angular momentum and are not subject to Pauli Exclusion Principal restrictions. They are classified as boson particles, and can react with each other. By this means NeuX particles 3, 4, or neutron bundles can be formed in an atomic core, as illustrated in FIG. 4

### Element Production

Element production is accomplished using the equipment and arrangement for the production of proton particles 8 that are injected upon neutron bundles 3,4. Proton 8 production is accomplished when a radioactive source 5 for alpha particles 6 is used to bombard a boron-10 target 7, and protons 8 subsequently flow to and integrate with neutron bundles 3,4 located in accumulator container 9.

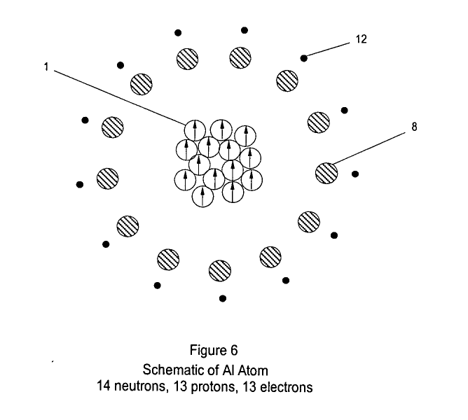

Proton particles 8 with a positive electrical charge are injected upon the neutron bundles 3, 4 located within container 9 to form specific elements as illustrated in FIG. 5. For illustration purposes in FIG. 5, a radioactive source 5 for alpha particles 6 is used to bombard a boron-10 target 7 to form the protons 8. These protons are injected upon neutron bundles 3. 4 located inside of container 9, to form particular elements and isotopes. That is where they are stored. The number of protons associated with neutron bundles is a natural association in the formation of elements and isotopes. FIG. 6 is a schematic illustration of an aluminum atom. The aluminum atomic core consists of 14 polarized neutrons 1, and 13 peripheral positively charged protons 8. Thirteen negatively charged orbital electrons 12 make the atom electrically neutral.

### Energy Production

According to Einstein's mass-energy equivalence statement E=MC², mass can be converted to energy. This is the principal used in this patent application for a new process for the production of nuclear binding energy from the interaction and nuclear fusion of bundles of neutrons, classified as boson particles. Neutron bundles, or Neu2 and Neu4 particles 3,4, are forced into contact with one another. The resultant nuclear interactions between neutron bundles releases binding energy at the expense of mass.

This is a new process for the production of nuclear binding energy from the interaction and nuclear fusion of bundles of neutrons 3,4, classified as boson particles.

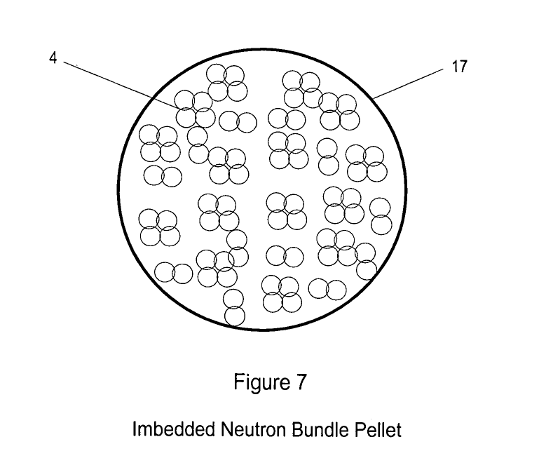

FIG. 7 illustrates a crushable spherical pellet that contains neutron bundles 3,4 imbedded in a matrix material to house and separate the neutron bundles.

FIG. 7 illustrates neutron bundle particles 4 imbedded in a matrix inside of a pellet with a crushable spherical casing 17. The pellet provides a convenient means for holding, transporting, and using the NeuX particles in energy applications.

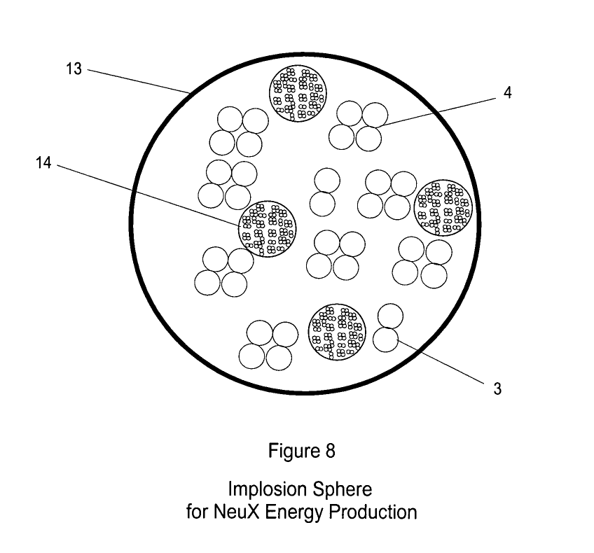

FIG. 8 shows an implosion sphere 13 for energy production from neutron bundles 3,4 and neutron bundle pellets 14 enclosed in a crushable containment sphere 17 that has a blanket of high explosive on the outer surface.

FIG. 8 is an illustration of an implosion sphere for energy production from neutron bundles, or Neu2 and Neu4 particles 3,4, and imbedded neutron pellets 14. Neutron bundles 3,4 and/or imbedded NeuX pellets 14 are enclosed in a containment sphere 13 that has a blanket of high explosive on the outer surface. Detonation of the high explosive blanket causes an external pressure on containment sphere 13 that forces sphere 13 to implode. Consequently, the enclosed neutron bundles 3,4 and also imbedded NeuX pellets 14, are forced into contact. This results in boson particle nuclear fusion interactions, which produce extremely large amounts of energy.

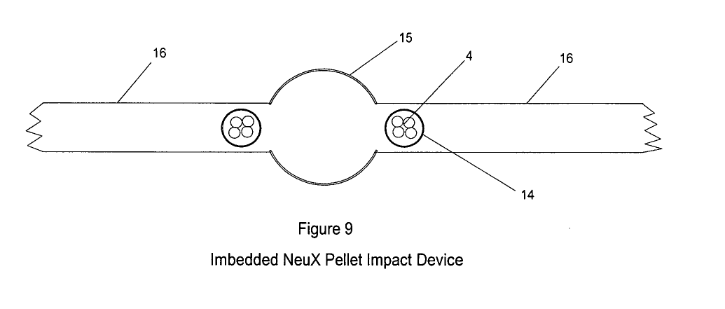

FIG. 9 illustrates another type of neutron bundle interaction device for the production of large amounts of nuclear binding energy. This is a pellet impact device with neutron bundle pellet injection tubes 16 on either side of a neutron bundle interaction chamber 15 to which the injection tubes 16 can continuously inject crushable neutron bundle pellets 14 for contact with each other resulting in nuclear fusion reactions and the release of large amounts of nuclear binding energy within interaction chamber 15. Imbedded neutron bundle pellets 14, that contain Neu2 and Neu4 neutron particles 3,4, are injected into neutron bundle interaction chamber 15 from neutron bundle pellet injector tubes 16. Large amounts of nuclear binding energy are released into interaction chamber 15 as a result of nuclear fusion interactions between the colliding imbedded NeuX pellets 14. This device is suitable for approximately steady state nuclear fusion energy production that offers many commercial applications.

FIG. 10 shows a neutron bundle nuclear chain reactor for the production of nuclear binding energy comprising a neutron source 21, electrical solenoid 22, fuel elements 19, and a control element 20. FIG. 10 is an illustration of a nuclear bundle nuclear chain reactor inside of container 18. Neutron source 21 injects neutrons into electrical solenoid 22 where the neutrons are oriented anti-polar with respect to atomic core neutrons in fuel elements 19. As described above, these anti-polar neutrons injected into polarized atomic core neutrons cause nuclear fusion reactions that produce Neu2 and Neu4 neutron bundle particles 3,4. These new neutron bundle particles 3,4 are classified as boson particles, and they can react with each other to produce nuclear fusion binding energy. This is a steady state continuous process that has many commercial applications such as electrical power plants and manufacturing facilities.

The fuel elements 19 can be made from any elements that can be fabricated into plates for these fuel elements 19. Examples of fuel materials are aluminum, beryllium, iron, tantalum, and yes, uranium.

This is the reason why neutron bundles 3,4 can be called the ultimate fuel. Any atom can be consumed by them for fuel.

This nuclear bundle nuclear chain reactor is controlled in much the same way as a regular nuclear fission reactor. Neutrons and neutron bundles 3,4 can be absorbed by an adjustable control element 20 made of material with a high absorption cross section such as boron-10 or cadmium. Power extraction is done by conventional systems, which include radiation cooling, convection, and the use of any gas such as hydrogen, helium, or carbon dioxide, for reactor core cooling.

I claim:

1. A new process for the formation and manufacture of elements and isotopes.

2. The formation of neutron bundles in claim 1 by nuclear fusion reactions when anti-polar neutrons are injected into an atomic core of polarized neutrons.

3. Equipment for the formation of neutron bundles in claim 2 consists of an accumulator container in which polarized atomic core neutrons of solid target material are located, and a thermal neutron source that feeds thermal neutrons into an electrical cable wound solenoid where the solenoid magnetic field orients the polarity of injected neutrons to oppose the polarity of the target material polarized core neutrons.

4. The formation of elements and isotopes in the process of claim 1, using neutron bundles of claim 2 formed by equipment in claim 3, by the injection of proton particles upon said claim 2 neutron bundles.

5. The equipment and arrangement for the production of proton particles of claim 4, for the process of claim 1, that are injected upon neutron bundles of claim 2, and described in claim 3 and claim 4, said proton production resulting when a radioactive source for alpha particles is used to bombard a boron-10 target, and subsequently to cause proton particles to flow to and integrate with claim 2 neutron bundles located in claim 3 accumulator container.

6. A new process for the production of nuclear binding energy from the interaction and nuclear fusion of bundles of neutrons, classified as boson particles, produced under claim 2 of the claim 1 process.

7. Under the energy process of claim 6, a crushable spherical neutron bundle pellet with neutron bundle particles of claim 2 imbedded in a matrix material to house and separate the neutron bundles inside of a pellet with a crushable spherical casing

8. Under the energy process of claim 6, an implosion sphere for energy production from interaction of neutron bundles of claim 2 and also interactions of crushable neutron bundle pellets of claim 7 enclosed in a containment sphere that has a blanket of high explosive on the outer surface.

9. Under the energy process of claim 6, a pellet impact device, for the production of nuclear binding energy, with neutron bundle pellet injection tubes on either side of a neutron bundle interaction chamber to which the injection tubes continuously inject crushable neutron bundle pellets of claim 7 for contact with each other resulting in nuclear fusion reactions and the release of large amounts of nuclear binding energy within the interaction chamber.

10. Under the energy process of claim 6, a neutron bundle nuclear chain reactor for the production of nuclear binding energy utilizing the methods and processes in claims 2, 3, and 6, and comprising a neutron source, electrical solenoid, fuel elements, and a control element.
